(19) United States
(12) Patent Application Publication
(10) Pub. No.: US 2012/0173402 A1
(43) Pub. Date: Jul. 5, 2012

(54) STORED VALUE EXCHANGE METHOD AND APPARATUS

(76) Inventors: Chris Nicolaidis, Encinitas, CA (US); Sateven J. Davis, Encinitas, CA (US)

(21) Appl. No.: 12/982,992

(22) Filed: Dec. 31, 2010

(51) Int. Cl. G06Q 40/00

(52) U.S. Cl. 705/37; 705/35

(57) ABSTRACT

An apparatus and method for exchanging one form of stored value for another form of value. In one embodiment, a method for exchanging stored value for an alternative form of value comprises receiving registration information from a remote entity, the registration information comprising attributes, such as a desired value provider and remote entity contact information. The registration information is stored in a storage device. Stored value account information is received from a second entity, the stored value account information comprising attributes relating to a stored value owned by the second entity. A processor then determines whether at least some of the attributes of the stored value account information matches at least some of the attributes of the registration information. If a match is found, a notification alert is generated and transmitted to the remote entity.

### BACKGROUND

I. Field of Use

The present application relates to the field of consumer stored value exchange methods and apparatus. More specifically, the present application relates to methods and apparatus for exchanging one form of stored value for an alternative form of value.

II. Description of the Related Art

Over the years, stored value cards, such as gift cards, have become popular with consumers. A typical stored value card is issued by a merchant in the shape of a credit card and contains magnetically encoded data. The data may be read by a magnetic card reader, which ascertains a value represented by the stored value card and a merchant associated with the stored value card.

Stored value cards typically come in one of two forms. “Closed” stored value cards can only be redeemed at merchants associated with the stored value card. “Open” stored value cards may be redeemed at a variety of merchant stores or websites.

Stored value cards are used to pay for products and/or services, typically by presenting the stored value card to a cashier or automated device, or by providing information found on the stored value card to a web-site that accepts stored value cards as payment. The merchant (or third party) determines the value of the stored value card and determines whether there is a sufficient balance on the stored value card to complete the purchase. If a sufficient balance exists, the transaction continues, and the monetary value encoded upon the stored value card is reduced by the purchase amount to reflect a new balance. Alternatively, the monetary value associated with the stored value card is reduced on a remote computer maintained by the stored value card vendor, merchant, or other party.

The fact that most stored value cards can be used only within a specific issuing chain of merchants can present problems to stored value card holders. A person may have received a stored value card that is usable at a particular merchant where the person does not desire to make a purchase. For example, a person may have received a stored value card that is redeemable at a home improvement store, but the person does not own a home and therefore has no interest in purchasing goods or services from the home improvement store. Or, the person may have received a stored value card that is only valid at a certain restaurant chain, but the person does not like the particular restaurant chain.

To address this problem, several websites, such as PlasticJungle.com, cardpool.com, SwapaGift.com, and others, offer a stored value card exchange service. Users of such sites can trade their stored value cards for other stored value cards redeemable at merchants from whom they would rather conduct business. Typically, a user accesses such a website, selects a merchant and a stored value card amount that the user would like to use, and enters information relating to the user's stored value card that he/she currently possesses. The value of the preferred stored value card is generally less than the value of the user's currently-possessed stored value card. Once the user selects a desired stored value card and value, the user mails the currently possessed stored value card to an address associated with the stored value card exchange website, and the desired stored value card is mailed to the user after the undesired stored value card is received by operators or owners of the stored value card exchange website.

One problem with the above-described scenario is that these sites offer only a limited way for gift card holders to exchange or sell their gift cards. As such, consumers may not receive as much value as they would like. For example, a gift card worth $50 might only fetch an offer of $30 of value from one of the aforementioned gift card exchange websites. This may discourage a user from trading in his or her stored value in a particular transaction and perhaps discourage the user from using such stored value exchange services in the future.

Another way that consumers can receive alternative value for their gift cards is to simply sell them to other individuals. Auction web-sites such as eBay are popular for allowing individuals to sell or auction goods and services to others. However, fraud is issue when purchasing gift cards from individuals not known to purchasers, because it is relatively easy to sell an invalid or already-used gift card to an anonymous individual over large geographic distances and not suffer legal consequences.

In the future, it is envisioned that these gift cards, and other forms of monetary value, will take forms other than the traditional, credit-card sized plastic cards that are popular with consumers today. For example, it is envisioned that mobile devices, such as consumer Smartphones, could be used to store, access, and exchange stored various forms of value for another form of value, such as merchandise, services, and other forms of value.

It would be desirable if stored-value owners could have alternative ways of selling or exchanging their gift cards, rather than the traditional exchange or auction websites. It would further be desirable for owners of stored value in general to be able to sell, exchange, auction, or otherwise transfer their stored value for an alternate(s) form of value.

### SUMMARY

The embodiments described herein relate to methods and apparatus for exchanging one form of stored value for another form(s) of value. In one embodiment, a method for exchanging stored value for an alternate form(s) of value is described, comprising receiving registration information from a first entity, the registration information comprising a desired value provider and first entity contact information. The registration information is then stored in a storage device. Stored value account information is then received from a second entity, the stored value account information relating to a stored value owned by the second entity. Next, a value provider associated with the stored value is determined from the stored value account information and then this value provider information is used to search the storage device for registration information containing a desired value provider matching the value provider information from the stored value account information. If a match is found, a notification alert is generated and sent to the first entity, using the first entity contact information.

In another embodiment, an apparatus for exchanging stored value for an alternate form(s) of value is described, comprising a storage device for storing registration information received from a first entity, the registration information comprising a desired value provider and first entity contact information. The apparatus further comprises a communication interface for receiving the registration information, for receiving stored value account information from a second entity, the stored value account information relating to a stored value owned by the second entity, and for transmitting a notification alert. The apparatus further comprises a processor for determining a value provider associated with the stored value from the stored value account information, for determining whether the value provider identified from the stored value account information matches the desired value provider from the registration information, and for generating the notification alert to the first entity if the value provider from the stored value account information matches the desired value provider from the registration information.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a system for exchanging stored value for another form(s) of value via a server;

FIG. 2 illustrates a user apparatus for conducting stored value transactions;

FIG. 3 is a functional block diagram illustrating the functional components of the server shown in FIG. 1; and

FIG. 4 is a flow diagram illustrating an embodiment of a process, performed by the server of FIG. 1, for exchanging one form of stored value for an alternative form(s) of value.

### DETAILED DESCRIPTION

The present specification is related to, and incorporates by reference, the following United States patent applications:

1. U.S. Ser. No. 12/909,818, filed Oct. 21, 2010

2. U.S. Ser. No. 12/945,861, filed Nov. 14, 2010

3. U.S. Ser. No. 12/945,862, filed Nov. 14, 2010

4. U.S. Ser. No. 12/945,863, filed Nov. 14, 2010

5. U.S. Ser. No. 12/945,864, filed Nov. 14, 2010

6. U.S. Ser. No. 12/945,865, filed Nov. 14, 2010

The present description relates to methods and apparatus for exchanging one form of stored value for another form of value. The term “value”, as used herein, comprises anything of monetary worth, such as money, credit, time (e.g., long-distance, payphone, or cell phone minutes), access to events, access to travel services, merchandise, social network credits (i.e., MySpace, FaceBook), gasoline, online credit (such as credit redeemable at Amazon.com), merchant credit (i.e., credit redeemable at a restaurant), coupons, and the like. The term “stored value” comprises any value that is, or can be, stored or represented in or on a physical object or device. Examples of a physical object or device comprise stored value cards, such as gift cards, credit cards, pre-paid phone cards, payroll cards, debit cards, wireless communication devices such as mobile telephones, Smartphones, mobile computing devices, such as an iPad or the like, fixed computing devices, servers, key fobs, vouchers, coupons, or any instrument useable in commerce in place of money, or any instrument that entitles the bearer to acquire, utilize, or exhaust any commercially available product or service. “Stored value account information” comprises one or more of the following: an account identification, such as an account number, an account value or balance, an amount of the account value or balance willing to be exchanged for another form of value, a face value, a market value, a desired selling price, a price that was paid by a seller of stored value for the stored value, an identity of the seller, a location of the seller, a seller's contact information, a preferred method of payment, a value provider, such as a merchant, service provider, individual, or financial institution associated with the stored value, value provider information pertaining to where the stored value may be redeemed, an identification of an account owner, an identification of a preferred value provider whom a user desires to transact future business, information relating to an “exchange option”, i.e., a selection by a user, at the commencement of an exchange, indicating a value type and a value amount preferred by the user, an expiration date, time, or period after which the stored value is no longer offered, and/or other information. Further, as used throughout this description, the term “card” shall be understood to include both prepaid and non-prepaid cards, unless the particular context requires otherwise. The term “value provider” shall be understood to mean any entity willing to exchange goods or services, in any form, for a user's stored value. Examples of such value providers comprise debit card companies, stored value exchange web sites, such as www.PlasticJungle.com, banks and other financial institutions, merchants such as retail stores, restaurants, movie theaters, grocery stores, etc., social networking websites such as MySpace and FaceBook, pre-paid phone card companies, pre-paid fuel companies, an individual using a computer, and so on. Finally, it should also be understood that exchanging stored value may comprise exchanging only some, or a portion of, any given stored value.

Stored value cards typically comprise plastic cards in the size and shape of a typical credit card, and often having a readable magnetic strip, bar code, computer/memory chip, smart chip, or the like embossed on one side. The magnetic strip is sometimes encoded with stored value account information, as defined above. In other embodiments, the strip comprises a unique identifying code which is used to access an account associated with the unique identifying number.

In the future it is contemplated that many forms of value will be electronically represented and stored on or in electronic devices for easy management by consumers, merchants, financial institutions, etc. Any form of value, such as money or credit, could be represented electronically and stored on a digital computing device such as a server, a personal computer, a mobile phone such as a Smartphone, etc. These digital computing devices will allow financial transactions to occur between, say, consumers and merchants by debiting a consumer's balance directly at the point of sale using, for instance, RF, BlueTooth, Wi-Fi, or other wireless technologies.

As stored value systems proliferate, it will be increasingly desirable to sell, exchange, auction, or otherwise transfer stored value from one entity to another.

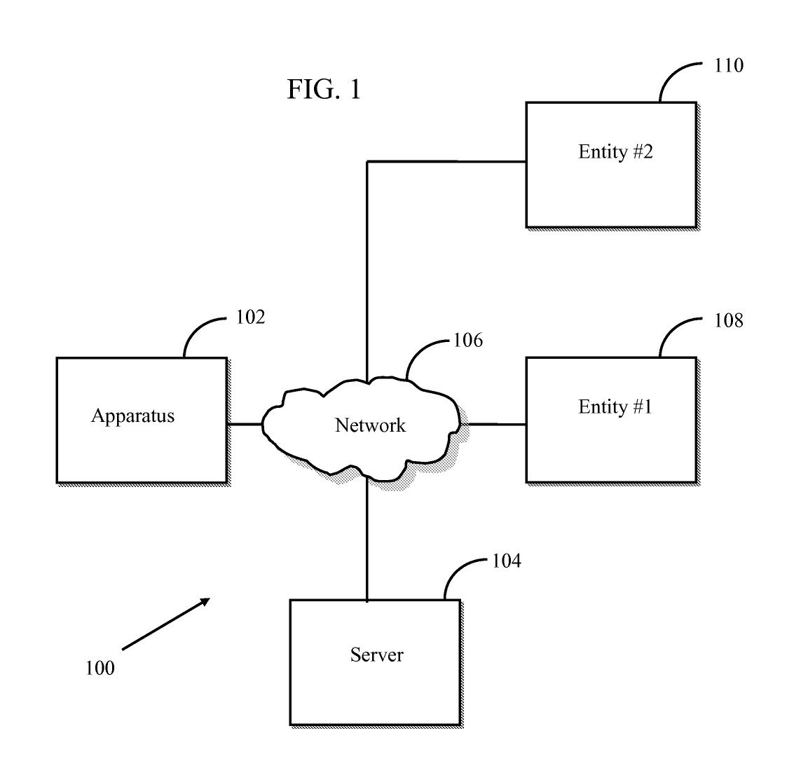

With the foregoing in mind, FIG. 1 illustrates a system 100 for exchanging stored value for another form(s) of value in accordance with one embodiment of the teachings of the present disclosure. In this embodiment, apparatus 102 comprises any electronic device capable of processing information and communicating over a network, such as a Smartphone (i.e., an iPhone sold by Apple Incorporated or a Droid sold by Verizon wireless), personal or mobile computer, personal digital assistant, etc.

In another embodiment, apparatus 102 comprises a kiosk, which, in general, is a transaction machine that is typically distributed publically for use by individuals. Kiosks have enjoyed a great deal of popularity in recent years, because they allow users to quickly purchase certain items without the use of human cashiers, which can sometimes slow down the purchasing process. A variety of items are typically offered by kiosks, such as lottery tickets, movie rentals, and of course, banking transactions.

An entity, such as an individual who owns or uses apparatus 102 or apparatus 102 itself, may use apparatus 102 to manage stored value that the owner/user may own or otherwise be entitled to manage. Managing stored value means acquiring, purchasing, selling, auctioning, swapping, viewing, transferring, or accessing any type of stored value. In one embodiment, apparatus 102 comprises a Smartphone executing a software application that allows a user of apparatus 102 to exchange stored value. The stored value may be stored within a memory within apparatus 102 or the stored value may be stored elsewhere, such as on a plastic card, or in an electronic memory in another electronic apparatus, such a personal computer owned by the user, on a server accessible to the user over a network, etc.

When an owner/user of apparatus 102 wishes to sell or exchange some or all of the owner/user's stored value, the owner/user can initiate a software application that manages the user's stored value by, for example, pressing an icon associated with such an application on a display of apparatus 102, or by other ways that are well-known in the art.

When the software application is initiated, a list of stored value may be displayed to the owner/user of apparatus 102, or the application might request that the owner/user enter stored value account information identifying stored value not presently held by apparatus 102. For example, the owner/user might have a first stored value in the form of a $100 credit to use at Home Depot (a home improvement store), a second stored value in the form of a $50 coupon to use at Best Buy, Inc. (an electronics retailer), a $30 gasoline credit to use at an Shell fuel station, and a credit worth $90 to use on a social networking site such as FaceBook. The stored value may be stored locally on apparatus 102 or it may be stored remotely on a server accessible to apparatus 102. The owner/user may wish to exchange one of these forms of value for an alternative(s) form of value. For example, the owner/user might want to exchange $75 of the value of the Home Depot credit for a credit for use at Sears Incorporated (a department store). The owner/user can use the application to select the type of value that he/she would like to exchange, an amount of the value that he/she would like to exchange (100% could be a default amount), and, possibly an identification of a type and value amount of an alternative form of value that the owner/user would like to receive. For example, the user/owner in this example could choose the Home Depot credit, select an exchange amount of $75 (out of the $100 available), and specify that he/she would like to receive a credit towards Sears, Inc., in an amount of at least $65.

The application running on apparatus 102 processes this information and then sends stored value account information to server 104 that is located remotely from apparatus 102, typically over a data network 106 such as the Internet. Of course, other forms of communication could be used alternatively, such as telephone networks, satellite networks, Wi-Fi networks, RF technology such as BlueTooth, or a combination of these. The stored value account information comprises attributes relating to the user/owner's stored value that he/she would like to exchange, for example, a value provider associated with the stored value (i.e., a merchant where the stored value may be redeemed) and a value (for example, a face value of the stored value). Server 104 comprises any well-known computing device used to send, receive, process, and store information.

The stored value account information is received by server 104, located remotely from apparatus 102 and connected to the data network 106. Server 104 determines, from the stored value account information, attributes of the stored value, such as value provider information and a value associated with the stored value. Server 104 then uses the attributes to determine whether any entities have pre-registered with server 104 to wish receive notification when stored value having particular attributes becomes available for purchase, auction, exchange, transfer, etc. In another embodiment, a single attribute, such as a value provider associated with the stored value, is used to determine whether a notification should be sent to pre-registered entities. In other embodiments, a combination of attributes are used to make the determination.

When server 104 determines that at least one entity has pre-registered with server 104 having at least one matching attribute with the stored value account information, a notification alert is transmitted from server 104 to the one or more identified entities, such as entity 108 and entity 110, alerting these entities that stored value matching at least one of the entity's 108 and 110 desired attributes. Entities, such as individuals, corporations, computers, merchants, websites, etc., can pre-register with server 104 by sending registration information to server 104 via network 106. The registration information typically comprises contact information for the entity, a desired value provider associated with stored value, and/or a desired value. The desired value may represent a value that the entity wishes to pay for the desired stored value, a face-value of the stored value, a cost to the seller of the stored value, an asking price, or a combination of these.

The notification alert is received by, in this example, entity 108 and entity 110. In response, each of these entities may respond to the notification alert with an offer to purchase or exchange the stored value for an alternative form(s) of value owned or managed by the entities. For example, entity 108 (an individual operating a Smartphone) wishes to be notified when a Home Depot credit is available for purchase, exchange, auction, or transfer. Entity 110 (an individual having both a Smartphone and personal computer) also wishes to be notified when a Home Depot credit is available for purchase, exchange, auction, or transfer. Both entities have pre-registered with server 104 by sending registration information comprising an attribute identifying a preferred value provider, in this case Home Depot. Each entity 108 and 110 receives a notification alert from server 104 via Smartphone and/or personal computer after server 104 determines that a Home Depot credit is available for purchase, exchange, auction, or transfer via receipt of stored value account information from an entity such as apparatus 102. In response to the notification alert, each entity 108 and 110, using the Smartphone, personal computer, or some other electronic device, may send an offer to exchange the $75 Home Depot credit for another form of value. In this example, entity 108 offers a $70 Lowes credit while entity 110 offers $65 in FaceBook credits.

The offers are received by server 104, which then forwards them to apparatus 102 via network 106. The owner/user using apparatus 102 then decides whether to accept either of the offers. Of course, the owner/user could receive more than just the two offers in this example, or it may receive one or even no offers. If the owner/user decides to accept one of the offers, an acceptance notification is sent to the entity who submitted the chosen offer, either directly using contact information provided along with the offer, or via server 104 (in this case, the owner/user decides to accept the $70 Lowes credit offer from entity 108). A rejection notification may be sent to any entity whose offer was not selected. If server 104 is used to process the acceptance notification, server 104 forwards the acceptance notification to entity 108, and the two forms of value are exchanged between the owner/user and entity 108. In one embodiment, an electronic transfer is conducted between the owner/user and entity 108, whereby $75 worth of value is subtracted from the Home Depot credit stored in apparatus 102 and transferred to the entity 108′s Smartphone, while $70 worth of value is subtracted from the Lowes value in the entity 108′s Smartphone and transferred to apparatus 102.

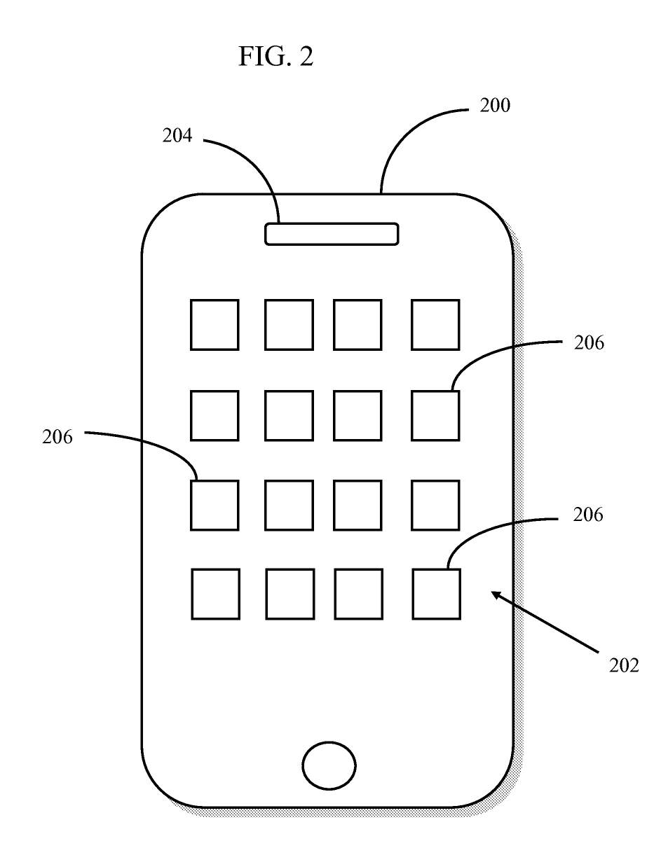

FIG. 2 is an illustration of an apparatus 102 (shown here as Smartphone 200), described above. In this example, Smartphone 200 typically comprises a display 202 for providing visual information to a user of Smartphone 200 and an audio output device 204, such as a speaker, for providing audio information. The display 202 typically comprises a touch-screen input device that allows a user to manipulate the functions provided by Smartphone 200. For example, a number of icons 206 displayed on display 202 acts as a launch point to initiate various applications stored on Smartphone 200 or otherwise available via a data network, such as the Internet. One of such applications comprises a stored value exchange application.

Display 202 typically comprises hardware and/or software necessary for a user of the Smartphone 200 to provide input to the Smartphone. Such hardware/software may comprise an electronic or “digital” keyboard displayed on display 202. In other embodiments, input is provided by a physical keyboard that may be part of Smartphone 200 or it may be connected to Smartphone 200 via a cable or wireless interface. In other embodiments, input is entered using a card reader, audio capture device, such as a microphone, and/or any other device for receiving electronic, RF, audio, or optical information that is well-known in the art. In yet another embodiment, the stored value account information is provided to Smartphone 200 by a remote entity, either wirelessly or through a cable connected to Smartphone 200. In this embodiment, stored value may be transferred from a secure entity, such as an electronic commerce website, financial institution, bank, credit card company, merchant, individual, server, etc., via a communication module inside Smartphone 200.

In one embodiment, stored value itself is received by Smartphone 200 and stored in a memory within Smartphone 200. In this embodiment, the stored value (i.e., store credit, e-money) stored within Smartphone 200 may be used at the point-of-sale when purchasing goods or services from the value provider. At the point-of-sale, the stored value in Smartphone 200 may be reduced, or debited, by a merchant having the necessary equipment to electronically access the Smartphone's stored value.

In another embodiment, information relating to stored value, such as an account number, is sent to Smartphone 200 so that the account may be accessed using Smartphone 200, while the stored value itself remains at a location remote from Smartphone 200. For example, a user may have purchased an electronic credit redeemable at a particular merchant using a credit card over the internet, and the electronic credit is stored on a server remote from Smartphone 200. When making a purchase, the account number stored in Smartphone 200 is accessed by a merchant and debits an account associated with the account number over a network.

In any case, stored value may be stored within a memory within Smartphone 200, or a representation of the value, such as an account number, may be stored within Smartphone 200.

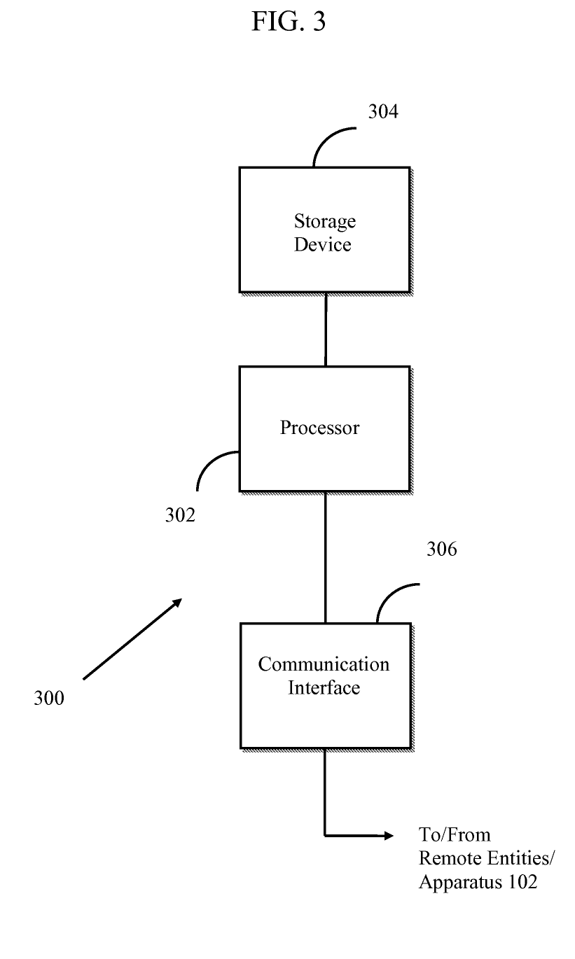

FIG. 3 is a functional block diagram of server 102 (shown here as server 300). It should be understood that in some embodiments, not all of the functional blocks will be required to enable stored value exchanges and that some functionality has been omitted for clarity.

Server 300 comprises a processor 302, a storage device 304, and a communication interface 306. Sever 300 is a computing device such as a computer, application server, web server, or other entity that provides transaction services on behalf of owner/user entities and entities wishing to purchase, exchange, or transfer certain types of stored value. Processor 302 comprises a general-purpose microprocessor well known in the art or it may comprise a custom or semi-custom ASIC able to carry out the functionality required for stored value exchange. Processor 302 generally executes processor-readable instructions stored in one or more mediums, such as storage device 302, that control most or all of the functionality of server 300. Storage device 304 comprises a processor-readable medium for storing processor-usable instructions for execution by processor 302. Examples of storage device 304 include an electronic memory such as RAM, ROM, hard drives, flash memory, EEPROMs, UVPROMs, etc. Communication interface 306 comprises hardware and/or software configured to receive and process communications from various entities connected to one or more communication networks, such as the Internet, a fiber optic network, a radio network, a wired or wireless telephone network, a satellite network, a wired or wireless data network, and/or any other well-known, two-way communication networks. Communication interface 306 allows server 300 to communicate with a variety of devices via the one or more communication networks, such as Smartphone 200, apparatus 102, fixed or mobile computers, personal digital assistants, kiosks, web servers, or virtually any other device, fixed or mobile, that is connected to one or more communication networks.

One purpose of server 300 is to pre-register remote entities wishing to receive notifications when stored value having particular attributes becomes available for purchase, exchange, auction, or transfer. A remote entity, such as an individual using a Smartphone, fixed or mobile computer, kiosk, etc., who wishes to be notified of such an event may access server 300 via a communication network, such as the Internet. The remote entity may provide registration information to server 300, comprising one or more of the following attributes: a desired type of stored value (i.e., an electronic credit, physical card, e-money, service, object, etc.), a desired value provider associated with the stored value, a desired category of stored value, a value associated with stored value (i.e., a face value, an asking price, a reserve price, an opening bid, a price that was paid by the entity offering the stored value, a number of credits, a maximum or minimum value that the entity is willing to pay for the stored value, etc.), a status of a seller (i.e., a seller who has a certain level of positive feedback from purchasers in prior transactions, who has sold a predetermined number of items or greater in the past, etc.), a time period or expiration date/time that the registration is valid, a desired type of transaction (i.e., sale, exchange, auction, or transfer), a location of the seller, a preferred method of payment, the entity's contact information, including a name, email address, account number, and/or telephone number, a preferred method of communication (i.e., telephone, email, text message, etc), a percentage discount (for example, the remote entity only wishes to receive notification alerts when stored value is available for more than a 20% discount off of its face value), as well as other types of information.

The registration information may indicate an interest in obtaining more than one item of stored value. For example, the registration information could comprise of a first information set comprising attributes for a first item of stored value and a second (and subsequent) information set comprising attributes for a second item of stored value. Each information set could specify different attributes for each item of stored value. For example, a first information set could specify stored value having Von's grocery store as a preferred value provider and an asking price of less than $100 and a second information set could specify stored value having McDonald's restaurant as the preferred value provider, a value of between $10 and $20, offered in the form of an electronic credit.

In one embodiment, registration information may be provided during acquisition of stored value. For example, a credit may be purchased online for use at a particular merchant or service provider. At some point during the payment process, the purchaser of the credit may be prompted to provide registration information to server 300 simply by providing an acknowledgement to the merchant or service provider. Upon receiving the acknowledgement, registration information relating to the stored value being purchased is sent to server 300 by the online merchant or service provider. For example, if an individual is purchasing a $100 airline ticket, at some point during the checkout process the individual is queried as to whether he/she would like to register information relating to the purchase with server 300. If the individual agrees, registration information is sent to server 300. In this case, the registration information might contain attributes such as the individual's name, an identification of the merchant or service provider, an amount of purchase, the individual's contact information, etc.

The registration information is received by server 300 via communication interface 306 and is stored in storage device 304 by processor 302. Processor 302 may, in addition, assign one or more attributes to the registration information, such as a date and/or time the registration information was received, the cumulative number of times a particular entity has registered with server 300 in the past, the number of times a particular entity has registered for a specific item of stored value, a status of each particular entity based on the number of times each entity has accessed server 104, or based on feedback from prior transactions, etc. After providing the registration information to server 300, server 300 may send a confirmation to the entity notifying the entity that the registration information was received and processed successfully.

A transaction fee may be charged to remote entities for registering with server 302, determined by processor 302. The transaction fee may be charged to remote entities each time registration information is received, on a time basis (i.e., a predetermined number of registrations over a month, year, etc), on the value specified in the registration information, or a combination of these things.

In addition to the registration information, server 300 also receives stored value account information from an entity wishing to sell, exchange, auction, or otherwise transfer stored value owned or managed by the entity. Examples of entities include an individual or business using an electronic device such as a Smartphone, computer, kiosk, or the like. Stored value account information relating to an entity's stored value is received by server 300 via communication interface 306. The stored value account information is then evaluated by processor 302 to determine various attributes, such as an account identification, such as an account number, an account value or balance, an amount of the account value or balance willing to be exchanged for another form of value, a face value, a market value, a desired selling price, a price that was paid by a seller of stored value for the stored value, an identity of the seller, a location of the seller, a seller's contact information, a preferred method of payment, a value provider, such as a service provider, individual, or financial institution associated with the stored value, value provider information pertaining to where the stored value may be redeemed, an identification of an account owner, an identification of a preferred value provider whom a user desires to transact future business, information relating to an “exchange option”, i.e., a selection by a user, at the commencement of an exchange, indicating a value type and a value amount preferred by the user, an expiration date, time, or period after which the stored value is no longer offered, and/or other information.

For example, processor 302 may evaluate the stored value account information and determine that the stored value offered by an entity is redeemable at a gasoline retailer, in this example, Exxon-Mobile. Processor 302 then uses this information to search storage device 304 to determine if a match can be found between this attribute (a value provider associated with the stored value) and a preferred value provider attribute identified in previously-received registration information.

A transaction fee may be charged to an entity that sends stored value account information to server 302, determined by processor 302. The transaction fee may be charged to an entity each stored value account information is received, on a time basis (i.e., a predetermined number of receipts over a month, year, etc), on a value specified in the stored value account information, or a combination of these things.

A match occurs when one or more attributes of the stored value account information matches some, or all, of the attributes specified in each information set stored in storage device 304. For example, a match may be determined when a merchant associated with stored value identified in received stored value account information matches a desired merchant provided in registration information sent by one or more entities. In another example, a match may be determined when a merchant associated with stored value identified matches a desired merchant provided in registration information and a value associated with the stored value identified in the stored value account information is less than, less than or equal to, greater than, or greater than or equal to, a preferred value identified in registration information.

For example, during the registration process, a remote entity may only wish to be notified when at least $50 worth of FaceBook credits are available for exchange with credits from an MySpace, an alternative social networking site to FaceBook. In another example, a remote entity may only wish to be notified when a McDonald's restaurant coupon or credit having a face value of $20 or less becomes available for purchase (rather than exchange, auction, transfer, or other means). Alternatively, a match may be determined when a value provider, value, and seller status is found to match. Or, in another embodiment, a match may be found when a general category of product/service determined from the stored value account information matches a desired category of product/service provided in the registration information. Virtually any combination of attributes may be used by processor 302 to determine a match.

When a match is found, processor 302 generates a notification alert to a remote entity associated with the match using contact information provided by the remote entity's registration information and stored in storage device 304. Of course, more than one match may be found. The notification alert may comprise one or more of the following: an identification of the stored value, including a value provider associated with the stored value, a stored value type, a value, an identity of the seller, a location of the seller, a seller's contact information, a transaction identifier, a preferred method of payment, etc. The notification alert is sent to the remote entity via communication interface 306. In one embodiment, the notification alert is sent using a desired type of communication as specified in the remote entity's registration information.

A transaction fee may be charged to each remote entity that receives the notification alert, determined by processor 302. The transaction fee may be charged to remote entities each time a notification alert is sent, on a time basis (i.e., a predetermined number of notifications over a month, year, etc), on the value specified in either the registration information or the stored value account information, or a combination of these things.

When the remote entity associated with the match receives the notification alert, the remote entity may choose to submit an offer to exchange the offered stored value for another form of value owned by the remote entity. The offer may comprise cash, credit, an electronic credit, electronic coupon, electronic money, a bid, an object, a service, or anything else of value. The offer may additionally comprise an identification of the stored value, a transaction identifier, an identification of the remote entity, contact information of the remote entity, a location of the remote entity, etc. The offer may, alternatively, simply comprise a message indicating that the remote entity would like to enter into negotiations to purchase or exchange the stored value.

In one embodiment, the offer is sent back to server 300, received by communication interface 306, and forwarded by processor 302, via communication interface 306 to the entity that is offering the stored value. In another embodiment, the offer is provided to the entity offering the stored value without assistance from server 300. In this embodiment, the notification alert comprises contact information of the entity and the contact information is used by the remote entity to send the offer.

In any case, the entity may receive more than one offer from more than one remote entity for the entity's stored value. The entity may accept one of the offers, reject all of them, or send a counter-offer to one or more of the remote entities. A notice of acceptance may be sent by the entity offering the stored value to the remote entity providing the selected offer and a notice of rejection to entities whose offers were not accepted. If a counter-offer is generated by the owner/user, it may be sent to all of the entities who submitted offers or to only a selected number of entities. Each of those entities may choose to re-submit their original offer, submit a better offer, or simply choose to drop out of contention for the stored value.

A transaction fee may be charged to the entity, the remote entity, or both, if an agreement is reached between the two entities to exchange their respective stored values, determined by processor 302. The transaction fee may be based on a value of the transaction, a one-time charge, or it may be assessed on a time basis (i.e., a certain number of acceptance alerts sent over a month, year, etc).

When an offer from a remote entity is accepted by the entity, the stored value is exchanged for an alternate value specified in the offer. This may be accomplished electronically or physically, or a combination of both. For example, if the entity's stored value comprises a $50 credit good for use at Home Depot stores and the offer comprises $50 in FaceBook credits, the $50 Home Depot credit can be electronically deleted from apparatus 102 (or a balance associated with the Home Depot credit reduced accordingly) and transferred to an electronic apparatus owned by the remote entity, while the $50 in FaceBook credits can be electronically transferred from the electronic apparatus held by the remote entity to apparatus 102. If the entity does not have a FaceBook account, an electronic credit can be made available to the entity, for example by email, if he/she subsequently opens a FaceBook account. In another example, if the entity's stored value comprises a $50 credit good for use at Home Depot stores and the offer comprises $50 in the form of a check, the entity could provide the $50 Home Depot credit electronically to the entity, and the remote entity could mail a check to the entity in the agreed-upon amount, in this case $50. Or, the remote entity could electronically transfer cash from an account owned by the remote entity, such as a bank account or credit card account, to apparatus 102. In that case, the remote entity's balance is reduced by the amount of the offer, in this case $50, or a credit card is debited by the offer amount.

The exchange of value between apparatus 102 and the remote entity may be accomplished using server 300 or not. If server 300 is used to aid in the exchange of value, server 300 may act as an escrow agent to ensure that each party provides value to server 300 before either party actually receives any value. For example, apparatus 102 might provide the $50 Home Depot credit to server 300, where it will be stored in storage device 304 until $50 in FaceBook credits is received by server 300 from the remote entity. After both forms of value have been received by server 300, the $50 FaceBook credit is provided to apparatus 102, while the $50 Home Depot credit is provided to the remote entity.

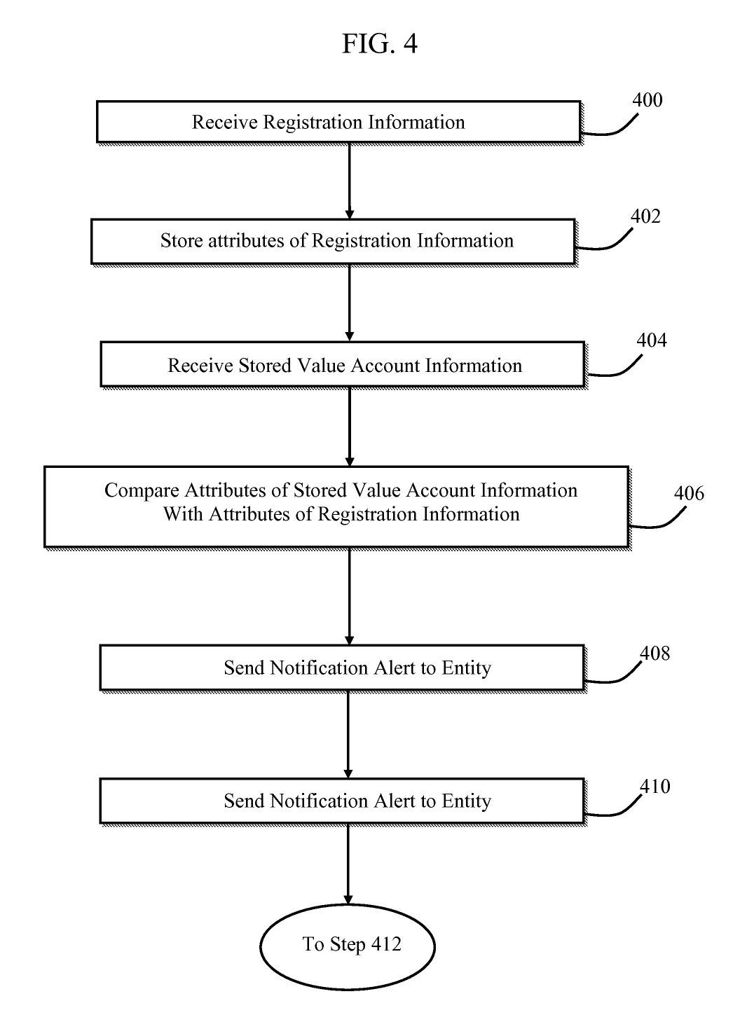

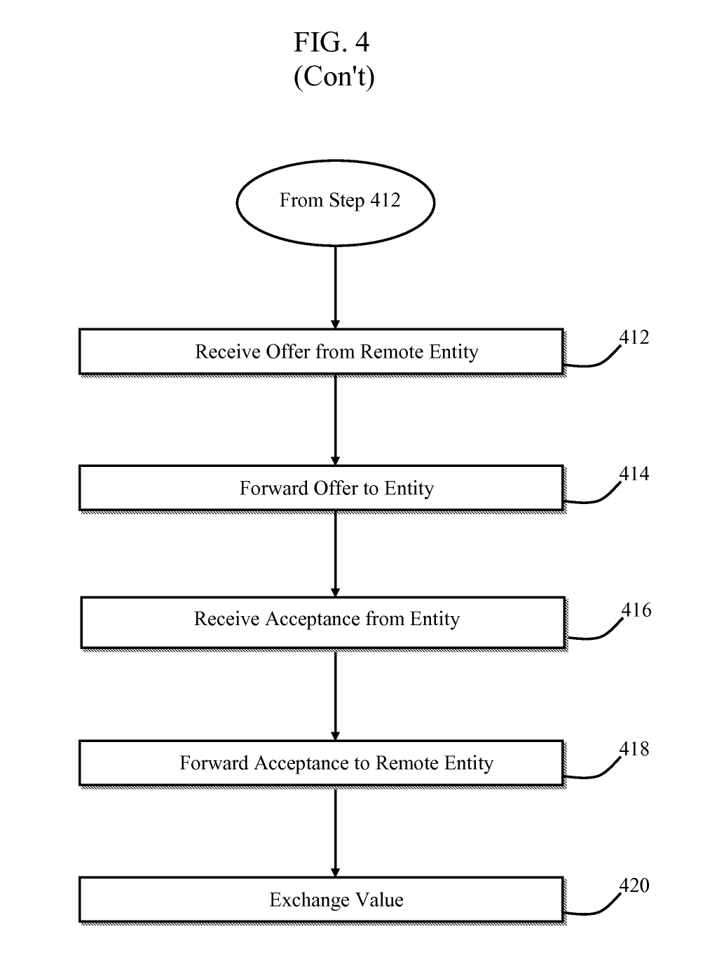

FIG. 4 is a flow diagram illustrating an embodiment of a process, performed by an apparatus, for example apparatus 300 shown in FIG. 3, for exchanging one form of stored value for an alternative form(s) of value. It should be understood that the steps presented in FIG. 4 is merely representative of one embodiment, and that a fewer, or greater, number of steps may be performed in alternative embodiments.

The process begins in step 400, where registration information is received by server 300.

In step 402, the registration information is stored in storage device 304 by processor 302.

In step 404, stored value account information is received from an entity of an apparatus, such as apparatus 200, wishing to sell, exchange, auction, or transfer stored value owned or managed by the entity.

In step 406, processor 302 compares attributes of the stored value account information to attributes of registration information received from one or more remote entities and stored in storage device 304. Processor 302 determines if a match is found between at least one of the attributes of the stored value account information and at least one of the attributes of the registration information stored in storage device 304. When a match of at least one of the attributes is found between the stored value account information and the registration information, a notification alert is generated by processor 302 in step 408. In another embodiment, the notification alert is generated only when multiple attributes in the registration information match attributes of the stored value account information.

In step 410, the notification alert is sent to any remote entity associated with match(es) found in step 406 using contact information associated with each remote entity and stored in storage device 304.

In step 412, an offer is received from at least one remote entity wishing to purchase, exchange, bid, or otherwise transfer an alternative form(s) of value for the entity's stored value. The offer is forwarded to the entity in step 414.

In step 416, an acceptance of the offer from the entity is received by server 300 and forwarded to the remote entity that provided the selected offer in step 418.

In step 420, the stored value owned by the entity is exchanged for the alternative form of value(s) offered by the remote entity.

The methods or steps described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention can include a computer readable media embodying a code or processor-readable instructions to implement the methods of operation of the kiosk in accordance with the methods, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

We claim:

1. A method for exchanging stored value for an alternative form of value, comprising:
receiving registration information from a first entity, the registration information comprising a desired value provider and first entity contact information;
storing the registration information;
receiving stored value account information from a second entity, the stored value account information relating to a stored value owned by the second entity;
determining a value provider associated with the stored value from the stored value account information;
determining whether the value provider associated with the stored value matches the desired value provider; and
sending a notification alert to the first entity, using the first entity contact information, if the value provider associated with the stored value matches the desired type of stored value.

2. The method of claim 1, wherein the registration information further comprises a desired value relating to the desired type of stored value, and the method further comprises:
determining the value of the stored value from the stored value account information;
determining whether the value of the stored value is less than or equal to the desired value; and
sending the notification alert to the first entity only if the value provider associated with the stored value matches the desired value provider and the value of the stored value is less than or equal to the desired value.

3. The method of claim 2, wherein the value of the stored value comprises an asking price.

4. The method of claim 1, further comprising:
receiving an offer to exchange the stored value for another form of value from the first entity;
sending the offer to the second entity;
receiving an acceptance of the offer from the second entity; and
forwarding the acceptance to the first entity.

5. The method of claim 1, further comprising:
charging a transaction fee when the stored value account information is received.

6. An apparatus for exchanging stored value, comprising:
a storage device for storing registration information received from a first entity, the registration information comprising a desired value provider and first entity contact information;
a communication module for receiving the registration information, for receiving stored value account information from a second entity, the stored value account information relating to a stored value owned by the second entity, and for transmitting a notification alert; and
a processor for determining a value provider associated with the stored value from the stored value account information, for determining whether the value provider identified from the stored value account information matches the desired value provider from the registration information, and for generating the notification alert to the first entity if the value provider from the stored value account information matches the desired value provider from the registration information.

7. The apparatus of claim 6, wherein the registration information further comprises a desired value relating to the desired value provider, and the processor is further for:
determining a value of the stored value from the stored value account information;
determining whether the value of the stored value is less than or equal to the desired value; and
generating the notification alert to the first entity only if the value provider identified from the stored value account information matches the desired value provider from the registration information and the value of the stored value is less than or equal to the desired value.

8. The apparatus of claim 7, wherein the value of the stored value comprises an asking price.

9. The apparatus of claim 6, wherein the communication module is further for receiving an offer to exchange the stored value for another form of value from the first entity, for sending the offer to the second entity, for receiving an acceptance of the offer from the second entity, and for forwarding the acceptance to the first entity.

10. The apparatus of claim 6, wherein the processor is further configured to charge a transaction fee when the stored value account information is received.

11. A processor-readable medium having processor-usable instructions stored thereon for execution by a processor to perform a method comprising:
receiving registration information from a first entity, the registration information comprising a desired value provider and first entity contact information;
storing the registration information;
receiving stored value account information from a second entity, the stored value account information relating to a stored value owned by the second entity;
determining a value provider associated with the stored value from the stored value account information;
determining whether the value provider associated with the stored value matches the desired value provider; and
sending a notification alert to the first entity, using the first entity contact information, if the value provider associated with the stored value matches the desired type of stored value.

12. The medium of claim 11, wherein the registration information further comprises a desired value relating to the desired type of stored value, and the method further comprises:
determining the value of the stored value from the stored value account information;
determining whether the value of the stored value is less than or equal to the desired value; and
sending the notification alert to the first entity only if the value provider associated with the stored value matches the desired value provider and the value of the stored value is less than or equal to the desired value.

13. The medium of claim 12, wherein the value of the stored value comprises an asking price.

14. The medium of claim 11, further comprising:
receiving an offer to exchange the stored value for another form of value from the first entity;
sending the offer to the second entity;
receiving an acceptance of the offer from the second entity; and
forwarding the acceptance to the first entity.

15. The medium of claim 11, further comprising charging a transaction fee when the stored value account information is received.
